(19) United States
(12) Patent Application Publication
(10) Pub. No.: US 2013/0171314 A1
(43) Pub. Date: Jul. 4, 2013

(54) COMPOSITIONS AND METHODS FOR CONTROL OF LISTERIA MONOCYTOGENES

(71) Applicants: Stephen G. Campano, Glen Allen, VA (US); Patrick Howard Hawkins, Blaine, MN (US); Frederick James Wagner, Golden Valley, MN (US); Tate M. Mathiason, Roseville, MN (US)

(72) Inventors: Stephen G. Campano, Glen Allen, VA (US); Patrick Howard Hawkins, Blaine, MN (US); Frederick James Wagner, Golden Valley, MN (US); Tate M. Mathiason, Roseville, MN (US)

(21) Appl. No.: 13/569,848

(22) Filed: Aug. 8, 2012

Related U.S. Application Data
(63) Continuation-in-part of application No. 12/845,595, filed on Jul. 28, 2010.
(60) Provisional application No. 61/229,609, filed on Jul. 29, 2009.

(51) Int. Cl. A23B 4/20

(52) U.S. Cl. CPC A23B 4/20
USPC 426/532; 514/557

(57) ABSTRACT

The present invention relates to methods for inhibiting the growth of pathogenic microbes in food products. In an embodiment, the invention includes an antimicrobial preservative composition for food products including potassium lactate, potassium acetate, and sodium diacetate. In an embodiment, the invention includes a food product including a meat; 1.5 to 1.8 parts of potassium lactate; 1.5 to 1.8 parts of potassium acetate; and 0.8 to 1.2 parts of sodium diacetate. In an embodiment, the invention includes a method of making a food product including adding an antimicrobial preservative composition to a composition comprising a meat, the antimicrobial preservative composition comprising potassium lactate, potassium acetate, and sodium diacetate. Other embodiments are also included herein.

This application is a continuation-in-part application of prior U.S. application Ser. No. 12/845,595, filed Jul. 28, 2010, which claims the benefit of U.S. Provisional Application No. 61/229,609, filed Jul. 29, 2009, the content of all of which are herein incorporated by reference.

### FIELD OF THE INVENTION

The present invention relates to food products and methods of making the same. More specifically, the present invention relates to methods and compositions for inhibiting the growth of pathogenic agents in food products.

### BACKGROUND OF THE INVENTION

Food borne illness remains an important public health problem. It has been estimated by the Centers for Disease Control (CDC) that over 76 million cases of foodborne disease occur each year in the United States. Many infections are relatively mild; however, food borne diseases are estimated to result in over 325,000 hospitalizations and 5,000 deaths annually. Common food borne pathogens include Clostridium, Campylobacter, Cryptosporidium, Cyclospora, Listeria, Escherichia coli (STEC) O157, Salmonella, Shigella, Vibrio, and Yersinia, amongst others.

As an example of one common pathogen, Listeria monocytogenes is a gram-positive bacterium commonly found in water and soil. L. monocytogenes is hardy and able to grow in temperatures ranging from 4° C. (39° F.), the temperature of a refrigerator, to 37° C. (99° F.), the body's internal temperature. In humans, L. monocytogenes can cause listeriosis, a potentially lethal food-borne infection. L. monocytogenes can also spread to the nervous system and cause meningitis. According to recent data from the Centers for Disease Control, as many as 86% of people infected with L. monocytogenes may require hospitalization.

L. monocytogenes has been found in uncooked meats, uncooked vegetables, unpasteurized milk, foods made from unpasteurized milk, and processed foods. L. monocytogenes can be killed by pasteurization and cooking. However, there remains a risk of contamination from post-lethality exposure in ready-to-eat foods such as hot dogs, deli meats, and various other delicacies.

### SUMMARY OF THE INVENTION

The present invention relates to methods and compositions for inhibiting the growth of pathogenic agents in food products. In an embodiment, the invention includes an antimicrobial preservative composition for food products including potassium lactate, potassium acetate, and sodium diacetate.

In an embodiment, the invention includes a food product including a meat; 1.5 to 1.8 parts of potassium lactate; 1.5 to 1.8 parts of potassium acetate; and 0.8 to 1.2 parts of sodium diacetate.

In an embodiment, the invention includes a method of making a food product including adding an antimicrobial preservative composition to a composition comprising a meat, the antimicrobial preservative composition comprising potassium lactate, potassium acetate, and sodium diacetate.

The above summary of the present invention is not intended to describe each discussed embodiment of the present invention. This is the purpose of the figures and the detailed description that follows.

### BRIEF DESCRIPTION OF THE DRAWINGS

The invention may be more completely understood in connection with the following drawings, in which:

FIG. 1 is a graph showing the growth of L. monocytogenes over time.

FIG. 2 is a graph showing the growth of L. monocytogenes over time.

FIG. 3 is a graph showing the growth of L. monocytogenes on scrapple over time.

FIG. 4 is a graph showing the growth of L. monocytogenes on hot dogs over time.

FIG. 5 is a graph showing the growth of L. monocytogenes on chicken/pork frankfurters over time.

FIG. 6 is a graph showing the growth of L. monocytogenes on slices of ham over time.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

While food borne illness has always been a concern, many indicators show that the incidence of food borne disease is on the rise around the world and is a substantial cause of morbidity and mortality. Pathogenic agents, such as Campylobacter, Cryptosporidium, Cyclospora, Listeria, Escherichia coli (STEC) O157, Salmonella, Shigella, Vibrio, and Yersinia are common causes of food borne illness.

Certain food products are inherently more susceptible to contamination with pathogenic microbes. For example, scrapple is an ideal substrate for L. monocytogenes growth because of relatively high water activity, relatively high moisture content, relatively low salt (NaCl) content, and near neutral pH. By way of example, the U.S. Department of Agriculture (USDA) Agricultural Research Service (ARS) surveyed and analyzed four commercial Scrapple brands for composition and found a relatively high water activity (0.97-0.98) and high moisture content (63.4-70.3%), a relatively low salt (NaCl) content (1.1-1.9%), and near neutral pH (5.4-6.4), which collectively makes it a favorable environment for the outgrowth of certain spoilage and pathogenic microbes, including L. monocytogenes. (Adekunle, A., Porto Fett, A. C., Call, J. E., Shoyer, B. A., Gartner, K., Tufft, L., Luchansky, J. B. 2009. Viability of Listeria monocytogenes surface inoculated onto slices of pork scrapple during storage at 4 degrees, 10 degrees, and 21 degrees Celsius. Meeting Abstract. (P-044-P421)).

However, Applicants have discovered that preservative compositions including potassium lactate, potassium acetate, and sodium diacetate can be used to inhibit the growth of pathogenic microbes in foods that are ideal growth substrates. Various aspects of embodiments included herein will now be described in greater detail.

### Process of Making Food Products

It will be appreciated that methods of making food products in accordance with embodiments herein can be applied to many different specific types of food, including specifically many different types of ready-to-eat (RTE) and uncured (containing no nitrite) meats.

In various embodiments the method can include a step of ingredient processing, including, for example, meat processing. Meat processing can include steps such as initial washing (with water or organic acid rinse) of the meat to be used in the formation of the food product. Meat processing can also include cutting, chopping, and/or grinding of the meat to be used in the formation of the food product.

After ingredients are processed they can be combined in order to form a mixture. Mixing can be performed to various levels of completion. In some embodiments, the ingredients are mixed until the resulting mixture is substantially homogenous. In other embodiments, the mixing may only result in a relatively heterogeneous mixture. Mixing of the ingredients can specifically include adding an antimicrobial preservative composition to a composition comprising a meat.

The total amount of the antimicrobial preservative composition mixed in with the rest of the ingredients can vary based upon the type of the food product (such as RTE or not), the specific components of the food product, etc. In some embodiments, the food product includes at least about 0.1% by weight total of potassium lactate, potassium acetate and sodium diacetate. In some embodiments, the food product includes at least about 0.5% by weight total of potassium lactate, potassium acetate and sodium diacetate. In some embodiments, the food product includes at least about 1.0% by weight total of potassium lactate, potassium acetate and sodium diacetate. In some embodiments, the food product includes at least about 2.0% by weight total of potassium lactate, potassium acetate and sodium diacetate. In some embodiments, the food product includes at least about 3.0% by weight total of potassium lactate, potassium acetate and sodium diacetate. In some embodiments, the food product includes from about 0.5% to about 1.5% by weight total of potassium lactate, potassium acetate and sodium diacetate.

In some embodiments, the food product includes 0.1 wt. % to 1.2 wt. % of potassium lactate, 0.1 wt. % to 1.2 wt. % of potassium acetate, and 0.01 wt. % to 0.25 wt. % of sodium diacetate. In some embodiments, the food product includes 0.15 wt. % to 0.5 wt. % of potassium lactate, 0.15 wt. % to 0.5 wt. % of potassium acetate, and 0.1 wt. % to 0.25 wt. % of sodium diacetate.

In various embodiments, methods of making food products included herein can include a step of cooking. It will be appreciated that cooking can take place at various temperatures and for various amounts of time depending on the particular product being made. In some embodiments, individual ingredients can be cooked before mixing the ingredients together. In some embodiments, cooking may take place after the ingredients are mixed together. Cooking can include the application of heat in various ways such as baking, boiling, frying, smoking or the like.

As a specific example of a method of making a food product, scrapple can be prepared starting with a food mixture comprising meat. In many cases the meat can include pork trimmings. The food mixture can also include head meat with or without skin, variety meats (heart or liver), and/or includes cereal grains (e.g. cornmeal, corn flour, or wheat flour). The meats can be cooked in a kettle or some other type of heated vessel in water to create a broth. The meat can be ground or minced. Broth, seasonings, and cereal can be mixed with the meat to create a mushy mixture. An antimicrobial preservative composition can be added and homogenously blended into the mixture. The resulting mixture can be formed into loaves using molds and allowed to cool and harden. Once the mixture is molded and cooled, the loaves are removed from the molds, vacuum-packaged, and refrigerated.

As another example of a method of making a food product, hot dogs can be made by processing meats, including but not limited to beef, pork, and poultry, by slicing, and/or grinding and chopping. The meat can be processed to form an emulsion or batter and can be combined with one or more of water, salt, flavorings, colorings, binders and extenders, sweeteners, and an antimicrobial preservative composition as described herein, amongst other ingredients. The antimicrobial preservative composition can be added during initial blending steps or can be added and mixed in homogenously during or after formation of the emulsion or batter. The resulting composition can be extruded into casings and then the hot dogs can be cooked. After cooling, the hot dogs can be removed from the casings and vacuum-packaged and refrigerated.

### Exemplary Food Products

Embodiments of the present invention can be used in making, and can include, a variety of food products. As an example, embodiments included herein can be used to make ready-to-eat (RTE) meat products. Examples of RTE meat products include wieners (hot dogs), frankfurters, bologna, all meat loaves (including chicken loaves, ham loaves, luncheon loaves, and other loaves, mixed loaves (with vegetables and with cereal), sausages (including pepperoni, firm types, and softer types), liver loaves, liver sausages, jerky, beef sticks, mortadella, and deli meats (including cold cuts such as turkey, chicken, ham, salamis, corned beef, and roast beef), amongst others. However, it will also be appreciated that embodiments herein can also be used to make other types of food products beyond RTE meat products.

As described above, foods that have low salt (NaCl) concentrations, high moisture content, and/or no sodium nitrite (e.g., uncured) present a particular risk with respect to food borne illness because they serve as an ideal substrate for the growth of many pathogens. Examples of such food products having one or more of these characteristics can include scrapple, liver mush, liver pudding, chitlin loaf, head cheese, corn meal mush, panhaas, and goetta. However, embodiments of the invention can be used to control the growth of pathogens on foods having these characteristics.

In an exemplary embodiment, methods included herein can be used to make food products having low salt content. For example, methods herein can be used to make food products having a salt concentration of less than about 1.9% by weight.

In an embodiment, the present invention can be used to make food products having high moisture content. For example, methods herein can be used to make food products having a moisture concentration of greater than about 60% by weight.

In an embodiment, the present invention can be used to make uncured food products. The term “uncured food products” as used herein shall refer to food products having little or no sodium nitrite. For example, methods herein can be used to make food products having a sodium nitrite concentration of less than about 20 parts per million or about 0.002% by weight. In yet another embodiment, methods herein can be used to make food products having no added sodium nitrite.

While embodiments herein can include food products that are uncured, low salt, and/or high moisture, it will be appreciated that other food products can also be made including compositions disclosed herein. For example, the present invention can include cured food products that are neither low salt nor high moisture. An example of such a food product is a hot dog (or frankfurter, wiener).

### Antimicrobial Preservative Compositions

In the present embodiment, an antimicrobial preservative composition can be added during a food-making process to inhibit the growth of pathogenic microbes. By way of example, embodiments herein can be used to control the growth of Clostridium, Campylobacter, Cryptosporidium, Cyclospora, Listeria, Escherichia coli, Salmonella, Shigella, Vibrio, and/or Yersinia. As a specific example, the antimicrobial preservative composition can be effective to inhibit the growth of Listeria monocytogenes on a food product. In some embodiments, the antimicrobial preservative composition is effective to limit growth of Listeria monocytogenes to less than 2 logs over the shelf life of the food product. In some embodiments, the antimicrobial preservative composition is effective to limit growth of Listeria monocytogenes to less than 2 logs over at least about 30 days.

The antimicrobial preservative composition can include potassium lactate, potassium acetate, and sodium diacetate. Those of skill in the art will appreciate that inclusion of a salt of an acid, as opposed to the acid itself can provide benefits in terms of ease of food formulation. However, either the acid or the salt of the acid can be used.

In some embodiments, the preservative composition can be formulated as a liquid in an aqueous solvent. In some embodiments, all components of the preservative composition are substantially dissolved in the aqueous solvent. In some embodiments, the preservative composition is a liquid with a solids content of between about 20 wt. % and about 80 wt. %. In some embodiments, the preservative composition is a liquid with a solids content of between about 50 wt. % and about 70 wt. %. In other embodiments, the preservative formulation can be formulated as a dry mix.

In various embodiments, the preservative composition includes potassium lactate. However, other alkali metal lactates can be used, such as, for example, sodium lactate or calcium lactate. It will be appreciated that references herein to lactate salts (such as potassium lactate) shall include the compound as a salt as well as its conjugate acid form (e.g., lactic acid) in relative amounts dependent upon pH.

The amount of the lactate salt can be sufficient to inhibit the growth of pathogenic microbes in conjunction with potassium acetate and sodium diacetate. In some embodiments, the amount of the lactate salt thereof in the preservative composition is at least about 10% by weight. In some embodiments, the amount of the lactate salt in the preservative composition is at least about 20% by weight. In some embodiments, the amount of the lactate salt in the preservative composition is at least about 30% by weight. In some embodiments, the amount of the lactate salt in the preservative composition is at least about 40% by weight. In some embodiments, the amount of the lactate salt in the preservative composition is from about 10% by weight to about 60% by weight.

As measured with respect to the food product itself, in some embodiments, the amount of the lactate salt can be from about 0.1% to about 5.0% by total weight of the food product. In some embodiments, the amount of the lactate salt can be from about 0.25% to about 4.8% by total weight of the food product. In some embodiments, the amount of lactate salt such as potassium lactate in the food product is less than or equal to 4.8 wt. %. In some embodiments, the amount of lactate salt such as potassium lactate in the food product is greater than or equal to 0.1 wt. %.

In various embodiments, the preservative composition includes potassium acetate and/or potassium diacetate. It will be appreciated that both acetate and diacetate are salts of acetic acid and both can be used in food formulations. Beyond potassium salts, other alkali metal acetates or diacetates can be used, such as, for example, sodium acetate or diacetate. It will be appreciated that references herein to acetate and/or diacetate salts shall include the compound as a salt as well as its conjugate acid form in relative amounts dependent upon pH.

The amount of the acetate and/or diacetate salt can be sufficient to inhibit the growth of pathogenic microbes in conjunction with the lactate salt. In some embodiments, the amount of the acetate and/or diacetate salt in the preservative composition is at least about 1% by weight for each of the two salts. In some embodiments, the amount of the acetate and/or diacetate salt in the preservative composition is at least about 10% by weight for each of the two salts. In some embodiments, the amount of the acetate and/or diacetate salt in the preservative composition is from about 1% by weight to about 20% by weight for each of the two salts.

As measured with respect to the food product itself, in some embodiments, the amount of the acetate and/or diacetate salt can be from about 0.01% to about 0.5% by weight of the food product for each of the two salts. In some embodiments, the amount of the acetate and/or diacetate salt can be from about 0.05% to about 0.25% by weight of the food product for each of the two salts. In some embodiments, the amount of the acetate and/or diacetate salt can be from about 0.1% to about 0.25% by weight of the food product for each of the two salts. In some embodiments, the amount of the acetate and/or diacetate salt in the food product is less than or equal to 1.0 wt. % for each of the two salts. In some embodiments, the amount of the acetate and/or diacetate salt in the food product is greater than or equal to 0.05 wt. % for each of the two salts.

In some embodiments, the relative amounts of components in the antimicrobial composition can be from about 1.2 to 2.1 parts lactate, 1.2 to 2.1 parts acetate and 0.5 to 1.5 parts diacetate. In some embodiments, the relative amounts of components in the antimicrobial composition can be from about 1.5 to 1.8 parts lactate, 1.5 to 1.8 parts acetate and 0.8 to 1.2 parts diacetate.

While not intending to be bound by theory, it is believed that the pH of the antimicrobial composition may impact the effect it has on various microbes. It will be appreciated that the composition will have a particular pH based on the specific components used to form the antimicrobial composition. It will also be appreciated that the composition will have a particular pH based on the nature and composition of the particular food product itself. However, the pH of the antimicrobial composition can also be adjusted via the addition of the acidic components of the antimicrobial blend or through the addition of basic components including, but not limited to, sodium hydroxide, potassium hydroxide, or sodium carbonate, for example.

In some embodiments, the antimicrobial preservative composition has a pH, as measured neat, from about 5.0 to about 9.0. In some embodiments, the antimicrobial preservative composition has a pH, as measured neat (in aqueous solution at approximately 50-70 wt. percent solids), from about 6.0 to about 8.0. In some embodiments, pH can be measured by first diluting the composition in water and then measuring the pH. For example, an antimicrobial solution can be diluted at 3% in deionized water and then the pH can be measured. In some embodiments, the antimicrobial preservative composition has a pH, as measured diluted at 3% in deionized water, from about 5.0 to about 9.0.

In some embodiments, the antimicrobial preservative composition is added as a single pre-mixed solution of lactate salt, acetate salt, and diacetate salt. In other embodiments, the antimicrobial preservative composition is added as a lactate salt solution, a separate acetate salt solution, and a separate diacetate salt solution.

### Further Additives

In various embodiments, further additives can be added to the food product. These further additives include, but are not limited to, flavorings, colorants, binders, grains, fillers, thickeners, and the like.

In some embodiments it can be desirable to provide flavoring agents to make the food products more palatable and as meat-like as possible and/or mask the taste associated with preservatives. Numerous patents disclose the use of flavoring agents for food products, and specifically, meat products. U.S. Pat. No. 2,934,437, for example, discloses the preparation of a meat-like flavor by reacting a mixture of monosaccharide and a source of amino acid. U.S. Pat. No. 3,394,015 discloses the preparation of a meat-like flavoring by reacting a proteinaceous substance with a sulfur-containing compound in the absence of a monosaccharide. U.S. Pat. No. 3,532,514 describes the preparation of a meat-like flavoring from a mixture of an amino acid source, a mono-, di-, tri-, or polysaccharide and an animal or vegetable fat. U.S. Pat. No. 3,394,017 describes the preparation of a meat-like flavoring by reacting thiamine with a sulfur-containing polypeptide or an amino acid mixture derived there from and thereafter adding aldehydes and ketones to the product. Further flavorings can include spices, spice extracts, oleoresins, herbs, dehydrated vegetable seasonings, condiments, and seasoning blends.

Colorants and pigments can also be added to the food product to make the food appear more palatable to the consumer. Many patents disclose products and method for coloring and controlling the appearance of food products, and specifically, meat products. For example, U.S. Pat. No. 4,001,446, discloses a process for forming a stabilized red color in an animal protein source containing iron. U.S. Pat. No. 4,262,022 teaches a process for producing a decolorized edible material from blood. U.S. Pat. No. 4,279,936 discloses a method for preserving pink meat color in canned, cooked “red” meat, in the absence of nitrites or nitrates. U.S. Pat. No. 4,599,234 provides compositions for curing meats comprising (di)nitrosyl ferrohemochrome and at least one antioxidant, at least one sequestering agent and at least one antimicrobial agent, wherein the compositions were said to bestow similar color, flavor, and microbiological stability as that associated with nitrite-treated meats.

Meat binders are commonly used in making meat products to improve flavor, stability, moisture retention, and improving slicing characteristics. A variety of such meat binders can be utilized in the present invention. Examples of meat binders and extenders that can be used include, but are not limited to, starch, soy protein concentrate (available as coarse granules, powder, or grits), and non-fat or calcium-reduced dried skim milk powder.

Cereal grains can also be added to the food product. Cereal grains can be either whole grains or processed grains. Such grains include, but are not limited to, rice, wheat, barley, sorghum, millets, oats, rye, and buckwheat.

Flavor enhancers can also be added. Such flavor enhancers include hydrolyzed (source) protein and monosodium glutamate (MSG).

Further additives that can be included in the present invention include antioxidants, bromelin, humectants, papain, citric acid, glucono-delta-lactone (GDL), sugars, corn syrup, gelatin, ficin, phosphates, ascorbate and erythorbate, and various texturizers/stabilizers/thickeners.

### EXAMPLES

### Example 1

### Comparison of Various Compositions

Various antimicrobial compositions were prepared. Specifically, antimicrobial preservative compositions were prepared by combining potassium lactate, potassium diacetate, and potassium propionate, in a solvent of water at various concentrations as shown in Table 1 below.

TABLE 1

| | Potassium Lactate | Potassium | Potassium |
|---|---|---|---|
| Composition | (Wt. %) | Diacetate (Wt. %) | Propionate (Wt. %) |
| A | 60 | 0 | 0 |
| B | 56 | 4 | 0 |
| C | 52 | 8 | 0 |
| D | 48 | 12 | 0 |
| E | 56 | 0 | 4 |
| F | 52 | 0 | 8 |
| G | 48 | 0 | 12 |
| H | 56 | 2 | 2 |
| I | 52 | 4 | 4 |
| J | 48 | 6 | 6 |
| K | 40 | 10 | 10 |

Amounts of the test composition were diluted with BHI (brain heart infusion) broth in order to form the various concentrations as indicated in Table 2.

A standard inoculum was prepared consisting of a 5-strain culture of L. monocytogenes. A volume of the standard inoculum was added to the diluted antimicrobial compositions.

TABLE 2

| | Test | Total Amount of | | Total | |
|---|---|---|---|---|---|
| Sample | Composition | Antimicrobial | | Antimicrobials | |
| ID | Used | Solution Used | | Used (Solids) | |
| Control | NONE | NONE | | NONE | |
| 1A | A | 6.25 | wt. % | 3.75 | wt. % |
| 2A | A | 12.5 | wt. % | 7.5 | wt. % |
| 3A | A | 25 | wt. % | 15 | wt. % |
| 1B | B | 6.25 | wt. % | 3.75 | wt. % |
| 2B | B | 12.5 | wt. % | 7.5 | wt. % |
| 3B | B | 25 | wt. % | 15 | wt. % |
| 1C | C | 3.125 | wt. % | 1.875 | wt. % |
| 2C | C | 6.25 | wt. % | 3.75 | wt. % |
| 3C | C | 12.5 | wt. % | 7.5 | wt. % |
| 1D | D | 3.125 | wt. % | 1.875 | wt. % |
| 2D | D | 6.25 | wt. % | 3.75 | wt. % |
| 3D | D | 12.5 | wt. % | 7.5 | wt. % |
| 1E | E | 3.125 | wt. % | 1.875 | wt. % |
| 2E | E | 6.25 | wt. % | 3.75 | wt. % |
| 3E | E | 12.5 | wt. % | 7.5 | wt. % |
| 1F | F | 3.125 | wt. % | 1.875 | wt. % |
| 2F | F | 6.25 | wt. % | 3.75 | wt. % |
| 3F | F | 12.5 | wt. % | 7.5 | wt. % |
| 1G | G | 3.125 | wt. % | 1.875 | wt. % |
| 2G | G | 6.25 | wt. % | 3.75 | wt. % |
| 3G | G | 12.5 | wt. % | 7.5 | wt. % |
| 1H | H | 3.125 | wt. % | 1.875 | wt. % |
| 2H | H | 6.25 | wt. % | 3.75 | wt. % |
| 3H | H | 12.5 | wt. % | 7.5 | wt. % |
| 1I | I | 3.125 | wt. % | 1.875 | wt. % |
| 2I | I | 6.25 | wt. % | 3.75 | wt. % |
| 3I | I | 12.5 | wt. % | 7.5 | wt. % |
| 1J | J | 3.125 | wt. % | 1.875 | wt. % |
| 2J | J | 6.25 | wt. % | 3.75 | wt. % |
| 3J | J | 12.5 | wt. % | 7.5 | wt. % |
| 1K | K | 3.125 | wt. % | 1.875 | wt. % |
| 2K | K | 6.25 | wt. % | 3.75 | wt. % |
| 3K | K | 12.5 | wt. % | 7.5 | wt. % |

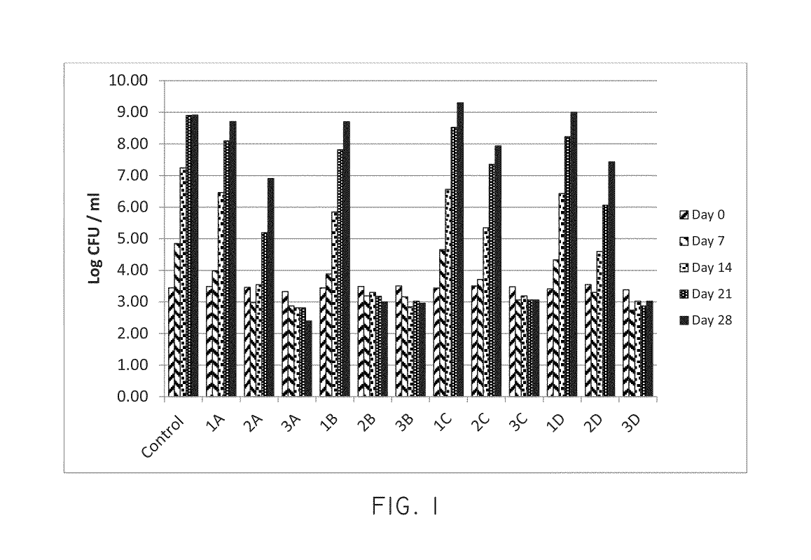

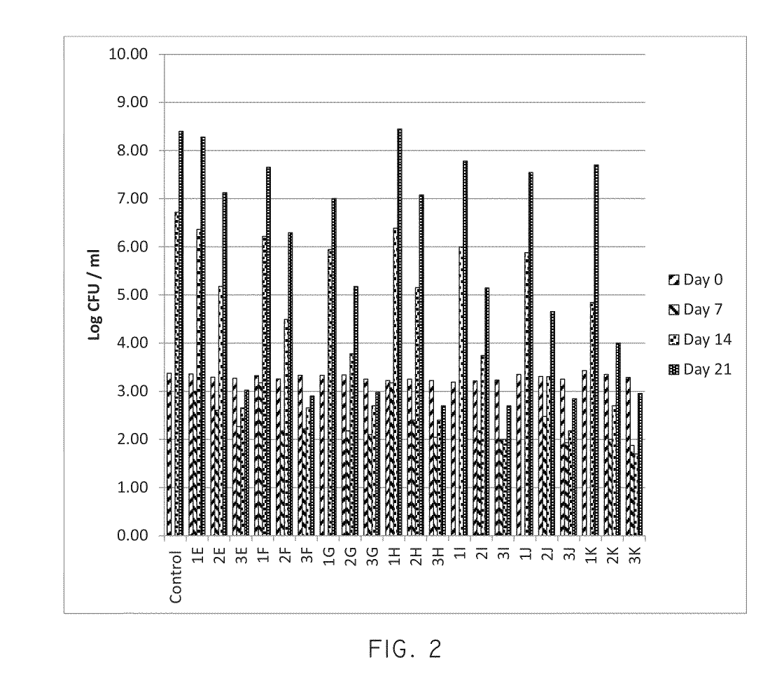

Test compositions were incubated at 4° C. Growth of L. monocytogenes was then assessed at various time points (0, 7, 14, 21, or 28 days). Specifically, samples were taken at the designated time points and growth was enumerated on modified Oxford (MOX) agar plates after incubation for 48 hours at 37° C. The results are shown in FIGS. 1-2.

### Example 2

### Inhibition of L. Monocytogenes Growth on Scrapple

An antimicrobial preservative composition was prepared by combining potassium lactate, potassium diacetate, and potassium propionate, in a solvent of water. The final composition of the antimicrobial preservative composition was 40 wt. % potassium lactate, 10 wt. % potassium diacetate, and 10 wt. % potassium propionate. The pH of the antimicrobial solution was a pH of 5.0 or 5.5 (measured as a 3% dilution in deionized water).

Scrapple was prepared according to industry standards. However, prior to setting the mixture into molds, a test composition was added and homogenously blended into the mixture.

In the first trial, the scrapple was combined with the antimicrobial preservative composition in an amount equal to 1.5% weight percent of the scrapple (e.g., preservative solids at 0.9% weight percent of the food product). In the first trial, some of the scrapple preparations included a flavor masking agent and some did not.

In the second trial, the scrapple was combined with the antimicrobial preservative composition in an amount equal to 1.94% weight percent of the scrapple (e.g., preservative solids at 1.16% weight percent of the food product). In the second trial, some of the scrapple preparations included a flavor masking agent and some did not.

In the third trial, the scrapple was combined with the antimicrobial preservative composition in an amount equal to 2.5% weight percent of the scrapple (e.g., preservative solids at 1.5% weight percent of the food product). In the third trial, some of the scrapple preparations included a flavor masking agent and some did not.

A control sample was included where the scrapple did not include the antimicrobial preservative composition.

Once the scrapple mixture was molded and cooled, the loaves were removed from the molds, vacuum packaged and refrigerated.

The scrapple loaf packages were then opened and surface-inoculated with a five-strain cocktail of L. monocytogenes, repackaged, and stored at 4° C. The five-strain cocktail included L. monocytogenes strains MFS-2 (serotype 1/2a, environmental isolate from a pork plant isolate), MFS-102 (H 7776, serotype 4b, frankfurter isolate), MFS-104 (Scott A serotype 4b, clinical outbreak), MFS-105 (LM-101M, serotype 4b, beef and pork sausage isolate) and MFS-110 (F6854, serotype 1/2a, turkey frankfurter isolate).

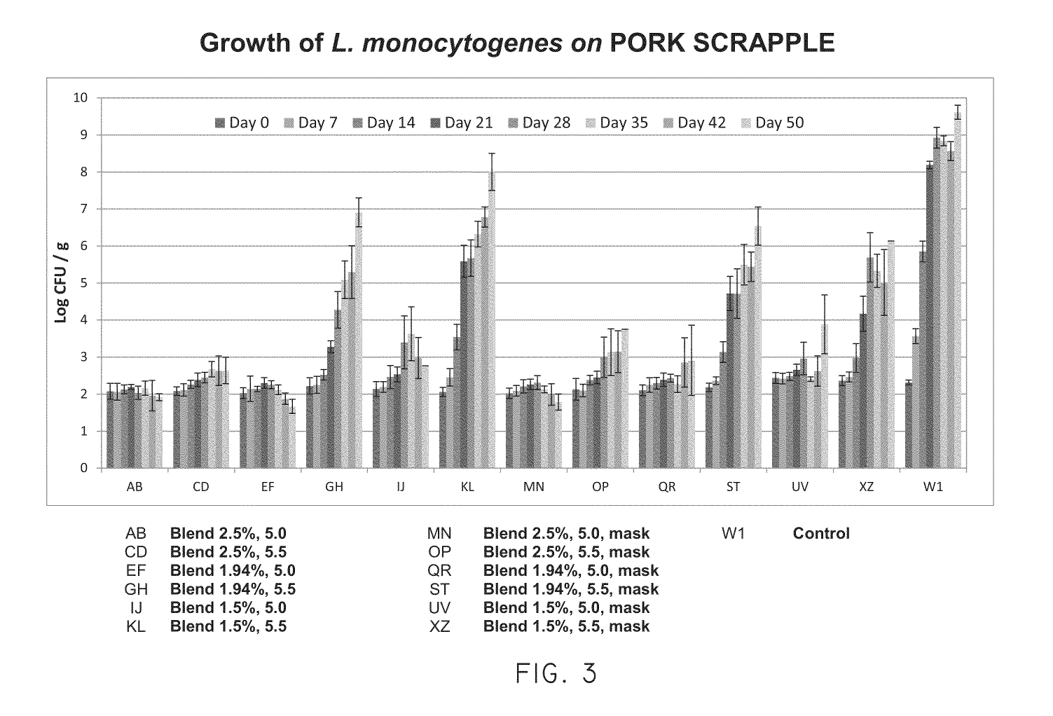

Growth of L. monocytogenes was then assessed at various time points (0, 7, 14, 21, 28, 35, 42, and 50 days). Specifically, samples were taken at the designated time points and growth was enumerated on MOX agar plates after incubation for 48 hours at 37° C. The results are shown in FIG. 3.

### Example 3

### Inhibition of L. Monocytogenes Growth on Hot Dogs

An antimicrobial preservative composition was prepared by combining potassium lactate, potassium diacetate, and potassium propionate, in a solvent of water. The final composition of the antimicrobial preservative composition was 40 wt. % potassium lactate, 10 wt. % potassium diacetate, and 10 wt. % potassium propionate. The pH of the antimicrobial solution was 5.5 (measured as a 3% dilution in deionized water).

Hot dogs were prepared according to industry standards. However, prior to extruding the hot dog batter (meat, curing agents, flavoring, etc.) into casings, a test composition was added and homogenously blended into the hot dog batter.

In the first treatment (A), the hot dog batter was combined with the antimicrobial preservative composition in an amount equal to 1.0% weight percent of the hot dog (i.e., preservative solids at 0.6% weight percent of the food product). In the first trial, some of the hot dog preparations included a flavor masking agent and some did not.

In the second treatment (B), the hot dog batter was combined with the antimicrobial preservative composition in an amount equal to 2.0% weight percent of the hot dog (i.e., preservative solids at 1.2% weight percent of the food product).

A control treatment (C) was included where the hot dog batter did not include the antimicrobial preservative composition.

Once the hot dog batter was extruded into casings and cooked then cooled, the resulting hot dogs were removed from the casings, vacuum packaged, and refrigerated.

The hot dog packages were then opened and surface-inoculated with a five-strain cocktail of L. monocytogenes, repackaged, and stored at 4° C. The five-strain cocktail included L. monocytogenes strains MFS-2 (serotype 1/2a, environmental isolate from a pork plant isolate), MFS-102 (H 7776, serotype 4b, frankfurter isolate), MFS-104 (Scott A serotype 4b, clinical outbreak), MFS-105 (LM-101M, serotype 4b, beef and pork sausage isolate) and MFS-110 (F6854, serotype 1/2a, turkey frankfurter isolate).

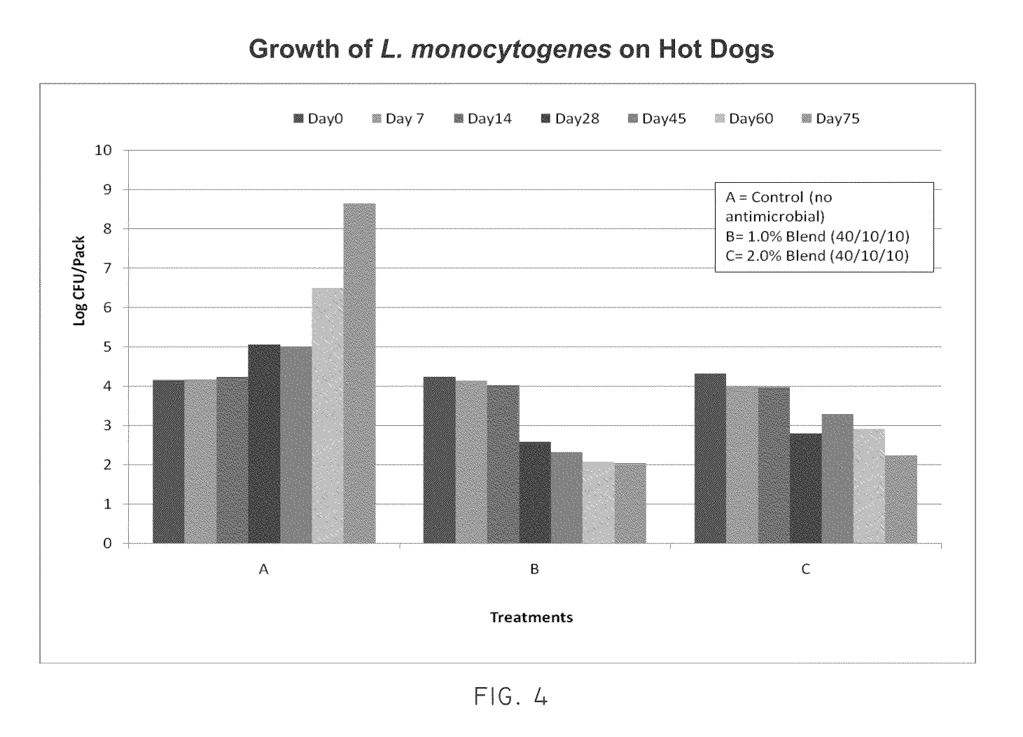

Growth of L. monocytogenes was then assessed at various time points (0, 7, 14, 28, 45, 60, and 75 days). Specifically, samples were taken at the designated time points and growth was enumerated on MOX agar plates after incubation for 48 hours at 37° C. The results are shown in FIG. 4.

### Example 4

### Preparation of Antimicrobial Compositions

Various antimicrobial compositions were prepared. Specifically, antimicrobial preservative compositions were prepared by combining potassium lactate, potassium acetate, and sodium diacetate, in a solvent of water at various concentrations as shown in the table below.

TABLE 3

| Test | Potassium | Potassium | Sodium | pH of Test |
|---|---|---|---|---|
| Composition | Lactate | Acetate | Diacetate | Compound |
| A | 56 | 0 | 4 | 6.92 |
| B | 68 | 0 | 10 | 7.20 |
| C | 68 | 0 | 10 | 7.34 |
| D | 0 | 33 | 20 | 6.85 |
| E | 0 | 32 | 20 | 7.11 |
| F | 23 | 23 | 14 | 6.89 |
| G | 23 | 23 | 14 | 7.31 |
| H | 0 | 50 | 0 | 6.42 |
| I | 0 | 50 | 0 | 6.85 |

The test compositions were diluted 1:1 in Tryptic Soy Broth with 0.6% yeast extract (TSBYE). Five ml of TSBYE and 100 μl of a multi-strain Listeria monocytogenes cocktail were mixed and 100 μl of this inoculum was added to each well of a 96-well microtiter plate. For each antimicrobial blend, 100 μl was added to the well labeled 1:1 and mixed by pipetting up and down three times. Using the same pipet tip, 100 μl of the diluted sample was transferred to the next well, and samples serially diluted this way, resulting in 2-fold dilutions, such that the final sample represented a 1:512, or 0.1% dilution of the antimicrobial. Additionally, positive and negative controls were prepared on each plate by addition of inoculum but no antimicrobial, or addition of antimicrobial but no inoculum. In each of two trials, microtiter plates were prepared in duplicate, and incubated at 15° C. for 7 days.

The absorbance (optical density) was recorded and inhibition of growth was determined and reported as Minimum Inhibitory Concentration (MIC). In addition, total antimicrobial solids required for inhibition was calculated and reported with corresponding MIC in the table below.

TABLE 4

| | MIC 1 (total | MIC 2 (total | Total solids |
|---|---|---|---|
| Test | solution required | solution required | required for |
| Composition | for inhibition) | for inhibition) | inhibition |
| A | 6.25% | 6.25% | 3.75% |
| B | 6.25% | 6.25% | 4.88% |
| C | 6.25% | 12.5% | 4.88%-9.75% |
| D | 1.56% | 1.56% | 0.83% |
| E | 12.5% | 12.5% | 6.50% |
| F | 1.56% | 1.56% | 0.94% |
| G | 3.125% | 1.56% | 1.88%-0.94% |
| H | 3.125% | 3.125% | 1.56% |
| I | 3.125% | 3.125% | 1.56% |

This example shows that test compositions D, F, and G were most effective in that they had the lowest Minimum Inhibitory Concentration (MIC). In particular, the efficacy of F and G (23% potassium lactate, 23% potassium acetate, and 14% sodium diacetate) was remarkable. While composition D performed well at a pH of 6.85, the nearly identical composition (E) lost significant efficacy at a pH of 7.11. In comparison, F (pH 6.89) and G (pH 7.31) were both extremely effective showing increased efficacy over a broader pH range.

### Example 5

### Inhibition of L. Monocytogenes Growth on Hot Dogs

An antimicrobial preservative composition was prepared by combining potassium lactate, potassium acetate, and sodium diacetate, in a solvent of water. The final composition of the antimicrobial preservative composition was 23 wt. % potassium lactate, 23 wt. % potassium acetate, and 14 wt. % sodium diacetate. The pH of the antimicrobial solution was 5.5 (measured as a 3% dilution in deionized water). Hot dogs were prepared according to industry standards. However, prior to extruding the hot dog batter (meat, curing agents, flavoring, etc.) into casings, a test composition was added and homogenously blended into the hot dog batter.

In the first treatment (A), the hot dog batter was combined with the antimicrobial preservative composition in an amount equal to 1.08 weight percent of the hot dog (i.e., preservative solids at 0.65 weight percent of the food product). In the second treatment (B), the hot dog batter was combined with the antimicrobial preservative composition in an amount equal to 1.25 weight percent of the hot dog (i.e., preservative solids at 0.75 weight percent of the food product).

A control treatment (C) was included where the hot dog batter did not include the antimicrobial preservative composition.

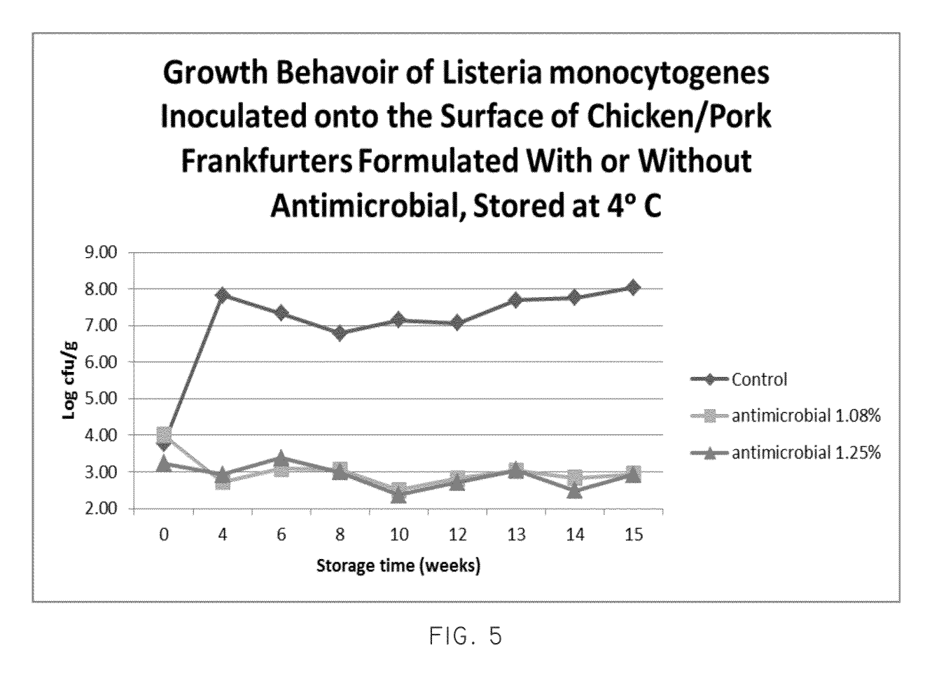

Once the hot dog batter was extruded into casings and cooked then cooled, the resulting hot dogs were removed from the casings, vacuum packaged, and refrigerated. The hot dog packages were then opened and surface-inoculated with a five-strain cocktail of L. monocytogenes, repackaged, and stored at 4° C. Growth of L. monocytogenes was then assessed at various time points (after 0, 4, 6, 8, 10, 12, 13, 14, and 15 weeks of refrigerated storage). Specifically, samples were taken at the designated time points and growth was enumerated on MOX agar plates after incubation for 48 hours at 35° C. The results are shown in FIG. 5. This example shows that the test composition achieved effective control of L. monocytogenes at both 1.08 and 1.25 wt. %.

### Example 6

### Inhibition of L. Monocytogenes Growth on Boneless Ham

An antimicrobial preservative composition was prepared by combining potassium lactate, potassium acetate, and sodium diacetate, in a solvent of water. The final composition of the antimicrobial preservative composition was 23 wt. % potassium lactate, 23 wt. % potassium acetate, and 14 wt. % sodium diacetate. The pH of the antimicrobial solution was 5.5 (measured as a 3% dilution in deionized water).

Boneless ham (ham and water product with 35% added ingredients) was prepared according to industry standards. However, prior to stuffing the boneless ham components (meat, curing agents, modified starch, etc.) into impermeable film, a test composition was added and homogenously blended into the ham.

In the test treatment, the boneless ham components were combined with the antimicrobial preservative composition in an amount equal to 1.74 weight percent of the ham (i.e., preservative solids at 1.04 weight percent of the food product).

A control treatment was included where the boneless ham components did not include the antimicrobial composition.

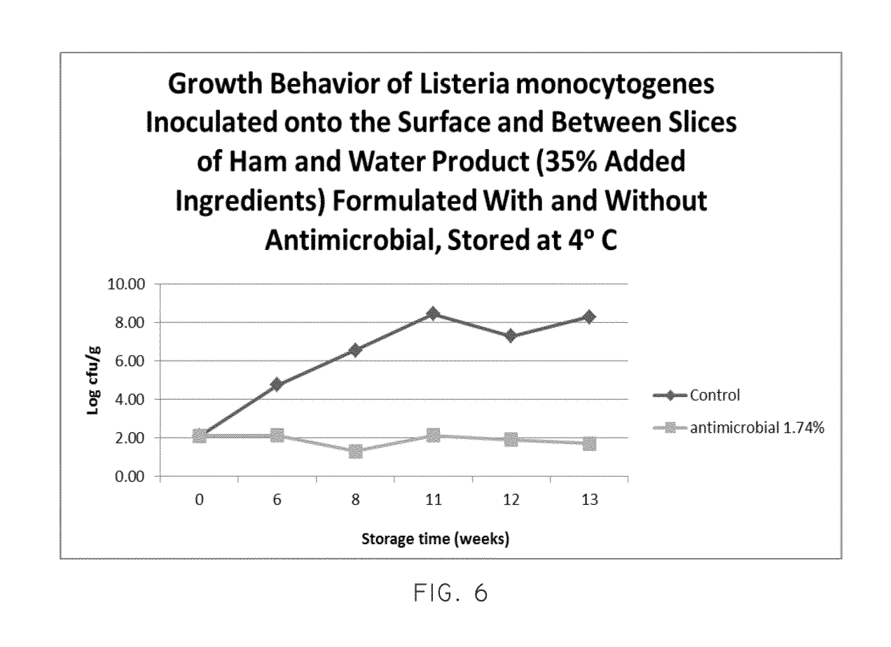

Once the boneless ham components were stuffed into film and cooked then cooled, the resulting ham was removed from the film, sliced, and inoculated (surface and between slices) with a five-strain cocktail of L. monocytogenes, vacuum packaged, and refrigerated at 4° C. Growth of L. monocytogenes was then assessed at various time points (0, 6, 8, 11, 12, and 13 weeks of refrigerated storage). Specifically, samples were taken at the designated time points and growth was enumerated on MOX agar plates after incubation for 48 hours at 35° C. The results are shown in FIG. 6.

While the present invention has been described with reference to several particular implementations, those skilled in the art will recognize that many changes can be made hereto without departing from the spirit and scope of the present invention.

The claims are:

1. An antimicrobial preservative composition for food products comprising:
potassium lactate,
potassium acetate, and
sodium diacetate.

2. The antimicrobial preservative composition for food products of claim 1, comprising:
18.5 to 26.0 wt. % potassium lactate;
18.5 to 26.0 wt. % potassium acetate; and
10.0 to 17.0 wt. % sodium diacetate.

3. The antimicrobial preservative composition for food products of claim 1, comprising:
21.5 to 23.0 wt. % potassium lactate;
21.5 to 23.0 wt. % potassium acetate; and
13.0 to 15.0 wt. % sodium diacetate.

4. The antimicrobial preservative composition for food products of claim 1, comprising:
23.0 wt. % potassium lactate;
23.0 wt. % potassium acetate; and
14.0 wt. % sodium diacetate.

5. The antimicrobial preservative composition for food products of claim 1, comprising:
1.5 to 1.8 parts lactate;
1.5 to 1.8 parts acetate; and
0.8 to 1.2 parts diacetate.

6. The antimicrobial preservative composition for food products of claim 1, the potassium lactate, potassium acetate, and sodium diacetate disposed together in an aqueous solvent, the composition having a solids content of between 20 wt. % and 80 wt. %.

7. A food product comprising:
a meat;
1.5 to 1.8 parts of potassium lactate;
1.5 to 1.8 parts of potassium acetate; and
0.8 to 1.2 parts of sodium diacetate.

8. The food product of claim 7, comprising:
0.1 wt. % to 1.2 wt. % of potassium lactate,
0.1 wt. % to 1.2 wt. % of potassium acetate, and
0.01 wt. % to 0.25 wt. % of sodium diacetate.

9. The food product of claim 7, comprising:
0.15 wt. % to 0.5 wt. % of potassium lactate,
0.15 wt. % to 0.5 wt. % of potassium acetate, and
0.1 wt. % to 0.25 wt. % of sodium diacetate.

10. The food product of claim 7, comprising an uncured food product.

11. The food product of claim 7, comprising a ready-to-eat (RTE) meat product.

12. The food product of claim 7, comprising a food product having a total moisture content of greater than about 60 percent by weight.

13. The food product of claim 7, comprising selected from the group consisting of hot dogs and deli meat.

14. A method of making a food product comprising:
adding an antimicrobial preservative composition to a composition comprising a meat, the antimicrobial preservative composition comprising
potassium lactate,
potassium acetate, and
sodium diacetate.

15. The method of claim 14, the food product comprising a sodium chloride content of less than about 1.9% by weight.

16. The method of claim 14, the food product comprising greater than about 60% by weight total moisture.

17. The method of claim 14, the food product comprising an uncured food product.

18. The method of claim 14, the antimicrobial preservative composition comprising
1.5 to 1.8 parts of potassium lactate;
1.5 to 1.8 parts of potassium acetate; and
0.8 to 1.2 parts of sodium diacetate.

19. The method of claim 14, wherein the antimicrobial preservative composition is effective to inhibit the growth of Listeria monocytogenes on the food product.

20. The method of claim 14, wherein the antimicrobial preservative composition is effective to limit growth of Listeria monocytogenes to less than 2 logs over the shelf life of the food product.

21. The method of claim 14, wherein the antimicrobial preservative composition is effective to limit growth of Listeria monocytogenes to less than 2 logs over at least about 30 days.
